(19) United States
(12) Patent Application Publication
(10) Pub. No.: US 2006/0051586 A1
(43) Pub. Date: Mar. 9, 2006

(54) Film for PDP filter, PDP filter comprising the same and plasma display panel produced by using the PDP filter

(76) Inventors: Sang Hyun Park, Daejeon-city (KR); Yeon Keun Lee, Daejeon-city (KR)

Correspondence Address: MCKENNA LONG & ALDRIDGE LLP, 1900 K STREET, NW, WASHINGTON, DC, 20006, US

(21) Appl. No.: 11/211,615

(22) Filed: Aug. 26, 2005

(30) Foreign Application Priority Data
Aug. 28, 2004 (KR) 10-2004-0068297
Jul. 30, 2005 (KR) 10-2005-0070056

(51) Int. Cl. C09K 19/00; H01J 61/40; B32B 9/04

(52) U.S. Cl. 428/411.1; 313/112; 428/1.31

(57) ABSTRACT

A film for a PDP filter including a binder resin composed of a styrene-acrylonitrile (SAN) copolymer, and a dye selected from the group consisting of a near infrared ray (NIR) absorbing dye, a Neon cut dye, a color control dye, and a mixture thereof is provided. The film for a PDP filter includes the SAN copolymer as a binder resin, and thus a change in transmittance is little under a high-temperature condition or a high-temperature and high-humidity condition, resulting in good durability and thermal stability and high transmittance in a visible light range. Further, since a general organic solvent can be used in the formation of the film, environmental pollution is reduced and the removal of a poisonous solvent is not required, thereby simplifying a process of forming the film.

### CROSS-REFERENCE TO RELATED PATENT APPLICATION

This application claims the benefit of Korean Patent Application No. 10-2004-0068297, filed on Aug. 28, 2004, and Korean Patent Application No. 10-2005-0070056, filed on Jul. 30, 2005, in the Korean Intellectual Property Office, the disclosures of which are incorporated herein in their entirety by reference.

### BACKGROUND OF THE INVENTION

1. Field of the Invention

The present invention relates to a plasma display panel (PDP) filter, and more particularly, to a film for a PDP filter with almost constant transmittance due to good thermal stability, a PDP filter comprising the same, and a PDP produced by using the PDP filter.

2. Description of the Related Art

Of flat panel display devices, a plasma display panel (PDP) is paid attention as a large sized panel. FIG. 1 is a perspective view of a PDP and FIG. 27 is a schematic diagram of a PDP assembly of the PDP. A PDP assembly is manufactured by forming barrier ribs on a lower plate, forming red, green and blue phosphor layers between barrier ribs, placing an upper plate on the lower plate such that electrodes on the lower plate are parallel to and face electrodes on the upper plate, and injecting a discharge gas such as Ne, Ar, Xe, etc., into spaces between the upper plate and the lower plate. A PDP is a next generation display that provides an image by combining light generated when ultra violet rays, emitted from plasma generated when discharging the gas by applying a voltage to a positive electrode and a negative electrode, make collision onto phosphors.

As illustrated in FIG. 27, since a PDP has electrodes supplying signals and power formed on an entire surface of a front glass, it generates electromagnetic waves more than other displays when being driven and also generates near infrared (IR) rays. The near infrared rays bring about malfunction in a remote control or an IrDA. Because they use the same light, the near IR range, for telecommunication. Further, discharge gas such as Ne, Ar, Xe, etc. is injected into the PDP, and then three initial color emission is achieved by emission of each of red, blue and green phosphors by vacuum UV rays. In this case, Ne emits orange light at around 590 nm when excited Ne atoms return to a ground state, and thus clear red light cannot be obtained.

To solve the problem of the PDP, a PDP filter 14 is installed in front of the PDP assembly 13. FIGS. 2 and 3 illustrate the ultimate installation purpose of the PDP filter. Referring to FIGS. 2 and 3, the PDP filter allows red (R), green (G) and blue (B) visible lights to pass through and filters orange light due to Ne at 590 nm, which degrades the resolution of a display, and near infrared ray (NIR) with a range of 800 to 1000 nm.

A PDP filter generally includes various films (an antireflection film (AR film), a NIR shielding layer (NIR absorption film or NIR film), a Neon cut layer (Neon cut film or color control layer), an electromagnetic interference shielding film (EMI film), etc.). The NIR absorption film and the Neon cut film are respectively formed by adding a NIR absorbing dye, a Neon cut dye, and a color control dye to a polymer resin and coating the mixture a transparent substrate.

The NIR shielding film for a PDP filter should have good durability even under a high-temperature condition or under a high-temperature and high-humidity condition, have high absorption rate to NIR with a wavelength range of 800-1200 nm, in particular 850-1000 nm, and have an UV transmittance of 60% or greater. The Neon cut film should have a maximum absorption wavelength around 570-600 nm. A narrower half width band of the NIR film and the Neon cut film is better, and the half width band is preferably 40 nm or less.

A binder resin used in the formation of the NIR absorption film or a NIR absorption/color control composite film can generally provide a transparent film. Examples of such a binder resin include polyester, acrylic, melamine, urethane, polycarbonate, polyolefin, polyvinyl, polyvinylalcohol, and polystyrene resins, and copolymers of these resins.

Examples of the NIR absorbing dye currently used include diimmonium salt, quinone, phthalocyanine, naphthalocyanine, metal complex, and cyanine (polymethine) dyes, which absorb NIR and transmit visible lights. Polymethine dyes or porphyrine dyes are widely used as the Neon cut dye.

The NIR absorbing dye or the Neon cut dye should have high absorption rate in an preferred wavelength range, have high transmittance to visible light, in particular be stable to heat generated in a PDP, and show good durability in a film formed from a mixture thereof with the binder resin. Of the above NIR absorbing dyes, phthalocyanine, naphthalocyanine, dithiol-based metal complex dye, etc. are known to have good thermal stability. However, these dyes cannot absorb NIR with a broad wavelength range in view of sharp NIR absorption peak and are expensive, resulting in an increase in the production costs of the NIR absorption film. Cyanine dyes have poor storage stability. For example, when cyanine dyes are stored at high temperature and high humidity for a long time, the durability is reduced.

Meanwhile, the diimmonium salt dye has a broad NIR absorption peak and high transmittance to visible light and is less expensive than phthalocyanine, naphthalocyanine, dithiol-based metal complex dyes, etc., and thus can reduce the production costs of the NIR absorption film. However, the diimmonium salt dye also has reduced NIR absorbing ability when it is stored at high temperature or at high temperature and high humidity for a long time. Further, the mechanical properties, such as the visible light transmittance, of the dye are changed, and thus the durability of the NIR absorption film is deteriorated. The durability of the NIR absorption film greatly depends on the type of the binder resin as well as the dye. Various binder resins have been developed to improve the durability of the diimmonium salt dye.

Korean Patent Application Nos. 2003-0030985, 2003-0047259(U.S. application Ser. No. 10/508221), and 2004-0053382 disclose a PDP filter using various binder resins.

U.S. Pat. No. 6,117,370 discloses a NIR absorbing filter prepared using a polycarbonate resin as a binder resin and a diimmonium dye as a NIR absorbing dye. Since chloroform used as a solvent in the formation of the film can cause ozone layer depletion, a recovery system of entire chloroform remained should be separately provided. Because the improvement in the thermal stability of the diimmonium dye is insufficient, a change in transmittance is still great after the diimmonium dye is stored at high temperature and high humidity for a long time.

U.S. Pat. No. 6,522,463 discloses a NIR absorbing filter produced using a polyester copolymer resin as a binder resin and a diimmonium dye as a NIR absorbing dye. Similarly to U.S. Pat. No. 6,117,370, poor thermal stability of the diimmonium dye still causes a great change in transmittance.

### SUMMARY OF THE INVENTION

The present invention provides a film for a PDP filter having good durability due to a low change in transmittance under a high-temperature condition or a high-temperature and high-humidity condition and reducing environmental pollution since general organic solvents can be used in the formation of the film.

The present invention also provides a PDP filter including the film.

The present invention also provides a PDP produced by using the PDP filter.

According to an aspect of the present invention, there is provided a film for a PDP filter including: a binder resin composed of a styrene-acrylonitrile (SAN) copolymer; and a dye selected from the group consisting of a near infrared ray (NIR) absorbing dye, a Neon cut dye, a color control dye, and a mixture thereof.

The content of an acrylonitrile unit in the binder resin may be 10-50 wt %.

The binder resin may have a weight average molecular weight of 10,000-1,000,000 and a glass transition temperature of 100-120° C.

The NIR absorbing dye may be a dye selected from the group consisting of diimmonium salt, quinone, phthalocyanine, naphthalocyanine, polymethine (cyanine) dyes, and a mixture thereof.

When the NIR absorbing dye is a diimmonium salt dye, a weight ratio of the binder resin and the NIR absorbing dye may be 5:1 to 200:1.

The Neon cut dye may have a maximum absorption wavelength of 570-600 nm and may be a polymethine dye or a porphyrine dye.

According to another aspect of the present invention, there is provided a PDP filter including the film.

According to another aspect of the present invention, there is provided a PDP produced by using a PDP filter.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a plasma display panel (PDP);

FIG. 2 is a schematic diagram illustrating the role of a PDP filter;

FIG. 3 is spectrums illustrating the role of a PDP filter;

FIG. 4 is transmission spectrums obtained before and after an endurance test for a film prepared in Example 1 at 80° C. for 500 hrs;

FIG. 5 is transmission spectrums obtained before and after an endurance test for the film prepared in Example 1 at 60° C. and a relative humidity (RH) of 90% for 500 hrs;

FIG. 6 is transmission spectrums obtained before and after an endurance test for a film prepared in Example 2 at 80° C. for 500 hrs;

FIG. 7 is transmission spectrums obtained before and after an endurance test for the film prepared in Example 2 at 60° C. and a RH of 90% for 500 hrs;

FIG. 8 is transmission spectrums obtained before and after an endurance test for a film prepared in Example 3 at 80° C. for 500 hrs;

FIG. 9 is transmission spectrums obtained before and after an endurance test for the film prepared in Example 3 at 60° C. and a RH of 90% for 500 hrs;

FIG. 10 is transmission spectrums obtained before and after an endurance test for a film prepared in Example 4 at 80° C. for 500 hrs;

FIG. 11 is transmission spectrums obtained before and after an endurance test for the film prepared in Example 4 at 60° C. and a RH of 90% for 500 hrs;

FIG. 12 is transmission spectrums obtained before and after an endurance test for a film prepared in Example 5 at 80° C. for 500 hrs;

FIG. 13 is transmission spectrums obtained before and after an endurance test for the film prepared in Example 5 at 60° C. and a RH of 90% for 500 hrs;

FIG. 14 is transmission spectrums obtained before and after an endurance test for a film prepared in Example 6 at 80° C. for 500 hrs;

FIG. 15 is transmission spectrums obtained before and after an endurance test for the film prepared in Example 6 at 60° C. and a RH of 90% for 500 hrs;

FIG. 16 is transmission spectrums obtained before and after an endurance test for a film prepared in Example 7 at 80° C. for 500 hrs;

FIG. 17 is transmission spectrums obtained before and after an endurance test for the film prepared in Example 7 at 60° C. and a RH of 90% for 500 hrs;

FIG. 18 is transmission spectrums obtained before and after an endurance test for a film prepared in Comparative Example 1 at 80° C. for 500 hrs;

FIG. 19 is transmission spectrums obtained before and after an endurance test for the film prepared in Comparative Example 1 at 60° C. and a RH of 90% for 500 hrs;

FIG. 20 is transmission spectrums obtained before and after an endurance test for a film prepared in Comparative Example 2 at 80° C. for 500 hrs;

FIG. 21 is transmission spectrums obtained before and after an endurance test for the film prepared in Comparative Example 2 at 60° C. and a RH of 90% for 500 hrs;

FIG. 22 is transmission spectrums obtained before and after an endurance test for a film prepared in Comparative Example 3 at 80° C. for 500 hrs;

FIG. 23 is transmission spectrums obtained before and after an endurance test for the film prepared in Comparative Example 3 at 60° C. and a RH of 90% for 500 hrs;

FIG. 24 is transmission spectrums obtained before and after an endurance test for a film prepared in Comparative Example 4 at 80° C. for 500 hrs;

FIG. 25 is transmission spectrums obtained before and after an endurance test for the film prepared in Comparative Example 4 at 60° C. and a RH of 90% for 500 hrs;

FIG. 26 is an exploded perspective view of a PDP according to an embodiment of the present invention; and

FIG. 27 is a schematic diagram of a panel assembly for a PDP according to an embodiment of the present invention.

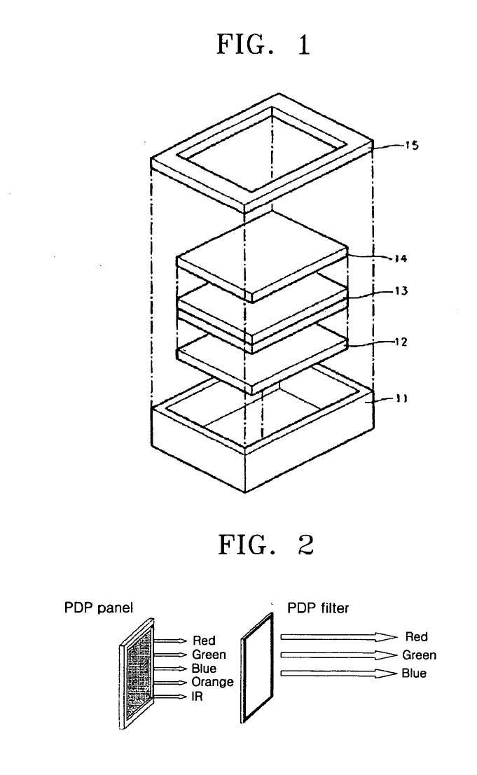

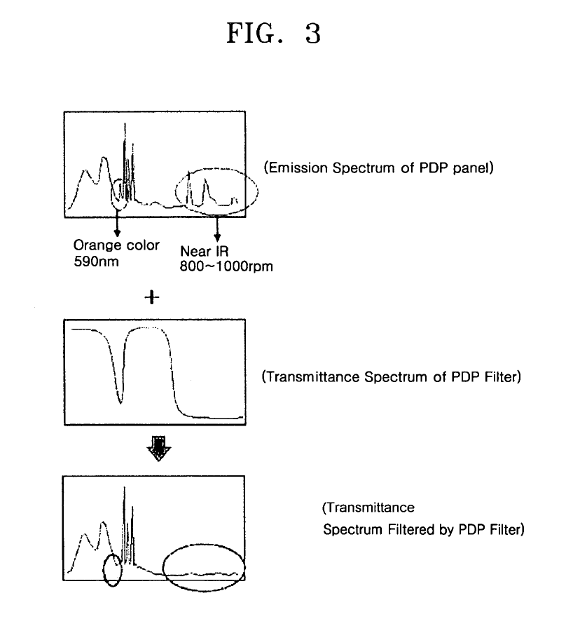

### DETAILED DESCRIPTION OF THE INVENTION

Hereinafter, the present invention will be described in greater detail.

A film for a PDP filter according to an embodiment of the present invention includes a styrene-acrylonitrile (SAN) copolymer as a binder resin, which can improve the thermal stability of conventional NIR absorbing dyes such as a diimmonium salt dye, and thus does not cause a change in the transmittance. For the SAN copolymer, general organic solvents can be used, and thus the film can be easily formed and environmental pollution can be reduced.

The SAN copolymer has good optical transparency, thermal resistance, dimensional stability, etc. In particular, due to a low change in transmittance under high-temperature condition or a high-temperature and high-humidity condition, the SAN copolymer has good durability and thermal stability.

The SAN copolymer may have a weight average molecular weight of 10,000-1,000,000 and a glass transition temperature Tg of 100-120° C. When the weight average molecular weight of the SAN copolymer is less than 10,000, heat resistance, chemical resistance, etc. are insufficient. When the weight average molecular weight of the SAN copolymer is greater than 1,000,000, polymerisation is difficult due to high viscosity, high polymerisation temperature and high reaction heat when producing the SAN copolymer. When the Tg of the SAN copolymer is lower than 100° C., the durability of a film is deteriorated due to its insufficient thermal resistance. When the Tg of the SAN copolymer is higher than 120° C., it is difficult to dissolve and handle it. The content of an acrylonitrile unit in the SAN copolymer may be 10-50 wt %. When the content of the acrylonitrile unit in the SAN copolymer is less than 10 wt %, thermal resistance and chemical resistance of the resin are reduced and the durability of a film is deteriorated. When the content of the acrylonitrile unit in the SAN copolymer is greater than 50 wt %, black spots are produced in the resin, and thus the SAN copolymer cannot be used as a transparent optical material.

A NIR absorbing dye useful in the present invention may be a dye selected from the group consisting of diimmonium salt, quinone, phthalocyanine, naphthalocyanine, metal complex, cyanine dyes, and a mixture thereof.

When the NIR absorbing dye is a diimmonium salt dye, a weight ratio of the binder resin and the NIR absorbing dye may be 5:1 to 200:1. When the weight ratio of the binder resin to the NIR absorbing dye is less than 5:1, the durability of a film is not improved. When the weight ratio of the binder resin to the NIR absorbing dye is greater than 200:1, the NIR absorption rate is reduced due to reduction in the amount of the dye.

The diimmonium salt dye may be a compound containing a diimmonium cation represented by formula (1): 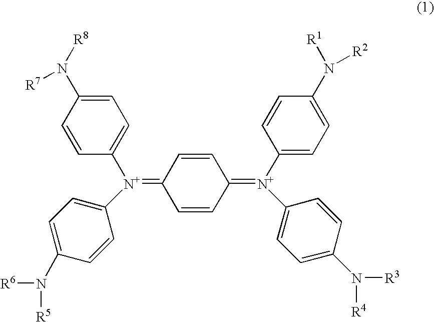
where R¹ to R⁸ are each independently a hydrogen atom, a substituted or unsubstituted C₁₋₁₆ alkyl group, or a substituted or unsubstituted C₆₋₃₀ aryl group.

The diimmonium salt dye may be composed of the diimmonium cation represented by formula (1) and a monovalent or divalent anion of an organic acid or an inorganic acid.

The monovalent anion of an organic acid includes organic carboxylate ions such as an acetate ion, a lactate ion, a trifluoroacetate ion, a propionate ion, a benzoate ion, an oxalate ion; a succinate ion and a stearate ion; organic sulfate ions such as a methanesulfonate ion, a toluene sulfonate ion, a naphthalene monosulfonate ion, a chlorobenzene sulfonate ion, a nitrobenzene sulfonate ion, a dodecylbenzene sulfonate ion, a benzene sulfonate ion, an ethane sulfonate ion and a trifluoromethane sulfonate ion; organic borate ions such as a tetraphenyl borate ion and a butyltriphenyl borate ion; and a trifluoro sulfoimide ion. As the divalent anion of an organic acid, naphthalene-1,5-disulfonic acid, naphthalene-1,6-disulfonic acid, derivatives of naphthalene disulfonic acid, etc. can be used.

The monovalent anion of an inorganic acid includes halogenide ions such as a fluoride ion, a chloride ion, a bromide ion, an iodide ion, a thiocyanate ion, a hexafluoroantimononate ion, a perchlorate ion, a periodate on, a nitrate ion, a tetrafluoroborate ion, a hexafluorophosphate ion, a molibdate ion, a tungstate ion, a titanate ion, a vanadate ion, a phosphate ion, a borate ion, etc.

The metal complex dye useful in the present invention may be a compound represented by formula (2) or (3): 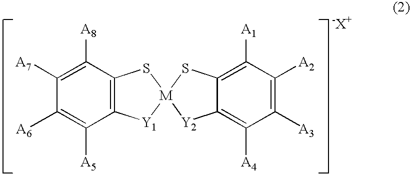
where A₁ to A₈ are each independently a hydrogen atom, a halogen atom, a nitro group, a cyano group, a thiocyanato group, a cyanato group, an acyl group, a carbamoyl group, an alkylaminocarbonyl group, an alkoxycarbonyl group, an aryloxycarbonyl group, a substituted or unsubstituted alkyl group, a substituted or unsubstituted aryl group, a substituted or unsubstituted alkoxy group, a substituted or unsubstituted aryloxy group, a substituted or unsubstituted alkylthio group, a substituted or unsubstituted arylthio group, a substituted or unsubstituted alkylamino group, a substituted or unsubstituted arylamino group, a substituted or unsubstituted alkylcarbonylamino group, or a substituted or unsubstituted arylcarbonylamino group, in which the substituent may be a halogen atom, a C₁₋₅ alkoxy group, a C₆₋₁₀ aryloxy group, or a C₁₋₁₆ alkylamino group; Y₁ and Y₂ are each independently oxygen or sulfur; X⁺ is a quaternary ammonium or a quaternary phosphonium; and M¹ is Ni, Pt, Pd or Cu, and 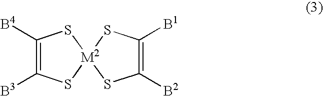
where B¹ to B⁴ are each independently a hydrogen atom, a cyano group, a hydroxy group, a nitro group, an alkoxy group, an aryloxy group, an alkylthio group, a fluoroalkyl group, an acyl group, a carbamoyl group, an alkylaminocarbonyl group, an alkoxycarbonyl group, an aryloxycarbonyl group, a substituted or unsubstituted aryl group, or a substituted or unsubstituted naphthyl group, in which the substituent is a halogen atom, an alkylthio group, a C₁₋₅ alkoxy group, a C₆₋₁₀ aryloxy group, or a C₁₋₁₆ alkylamino group; and M² is Ni, Pt, Pd or Cu.

Among NIR absorbing dyes useful in the present invention, the phthalocyanine dye may be a compound represented by formula (4) and the naphthalocyanine dye may be a compound represented by formula (5): 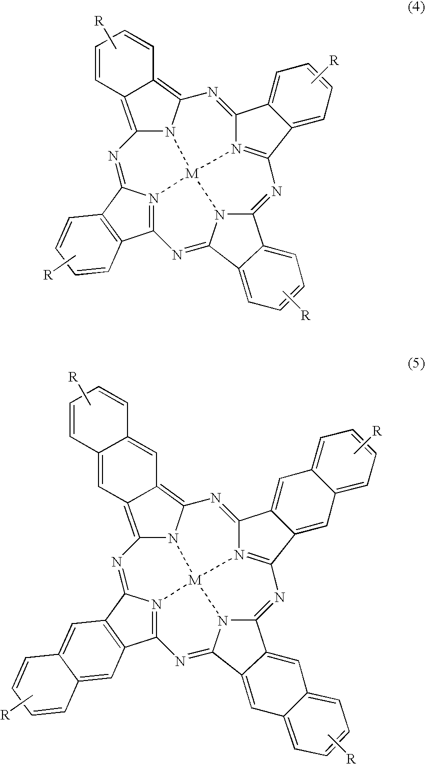
where R is a hydrogen atom, a halogen atom, a substituted or unsubstituted alkyl group, a substituted or unsubstituted aryl group, a substituted or unsubstituted alkoxy group, a substituted or unsubstituted aryloxy group, or a substituted or unsubstituted 5-membered ring having at least one nitrogen atom, in which the substituent is a halogen atom, an alkylthio group, a C₁₋₅ alkoxy group, a C₆₋₁₀ aryloxy group, or a C₁₋₁₆ alkylamino group.

Among NIR absorbing dyes useful in the present invention, the cyanine dye may be a compound represented by formula (10):
Ar₁-A-Ar₂ (10)
where A is a substituted or unsubstituted C₅₋₇ hydrocarbylene group forming a conjugated double bond; and Ar₁ and Ar₂ are each independently a substituted or unsubstituted aryl group, a substituted or unsubstituted heterocyclic group, or a polycyclic group having a substituted or unsubstituted heterocycle.

More particularly, A may be 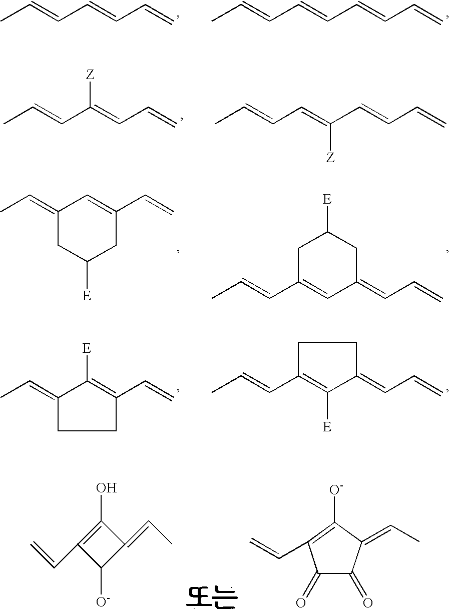
In the above formulae, Z is a hydrogen atom, a halogen atom, a cyano group, a C₁₋₈ alkyl group, or C₆₋₁₀ aryl group and E is a halogen atom, a nitro group, a cyanine group, a sulfonic group, a sulfonate group, a sulfonyl group, a carboxyl group, a C₂₋₈ alkoxycarbonyl group, a phenoxycarbonyl group, a carboxylate group, a C₁₋₈ alkyl group, a C₁₋₈ alkoxy group, or a C₆₋₃₀ aryl group.

More particularly, Ar₁ and Ar₂ may be

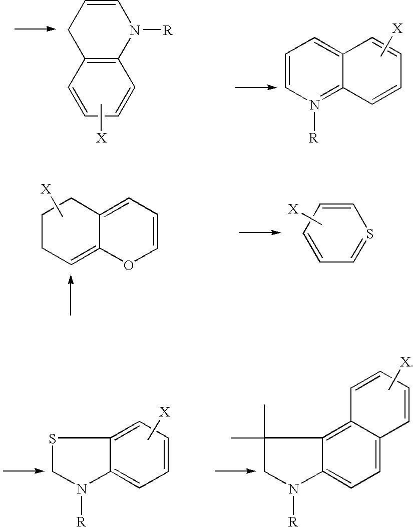

In the above formulae, X can be substituted anywhere in an aromatic ring and examples thereof include a halogen atom, a nitro group, a cyanine group, a sulfonic acid group, a sulfonate group, a sulfonyl group, a carboxyl group, a C₂₋₈ alkoxycarbonyl group, a phenoxycarbonyl group, a carboxylate group, a C₁₋₈ alkyl group, a C₁₋₈ alkoxy group, and a C₆₋₃₀ aryl group; and R is as defined in formula (5).

The cyanine dye useful in the present invention may be at least one compound selected from the group consisting of compounds represented by formulae (11) to (18):

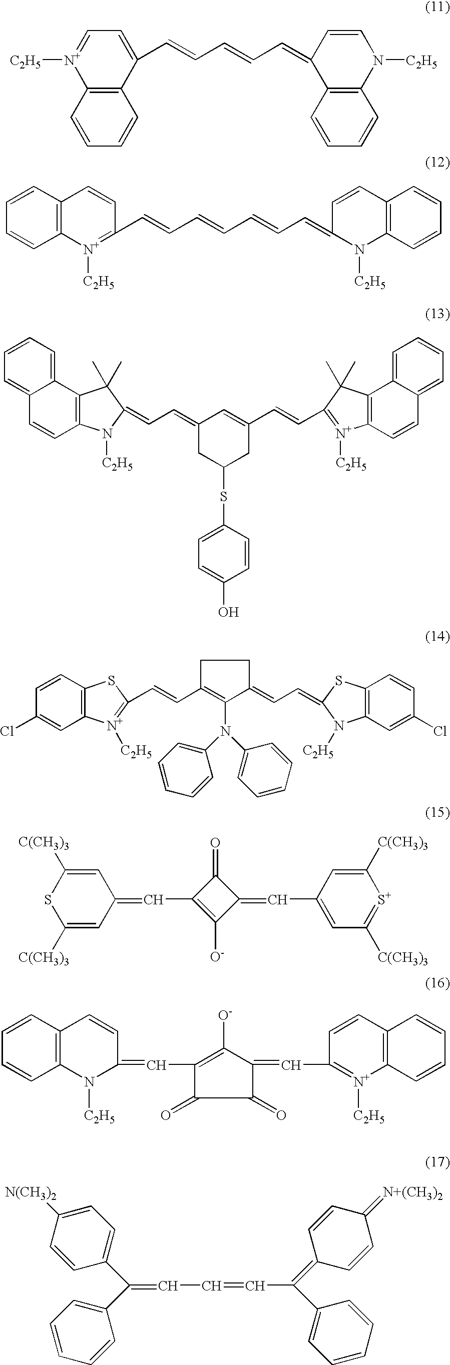

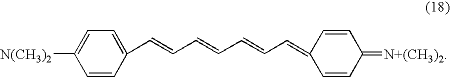

A Neon cut dye useful in the present invention has a maximum absorption wavelength of 570-600 nm and may be a polymethine dye represented by formula (6), (7) or (8) or a porphyrine dye represented by formula (9):

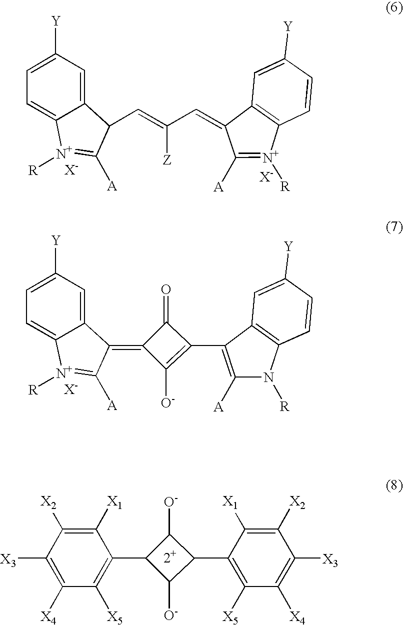

where R is a hydrogen atom or a C₁₋₁₆ aliphatic hydrocarbon; A is a hydrogen atom, a C₁₋₈ alkyl group, or C₆₋₃₀ aryl group; Y is a halogen atom, a nitro group, a cyanine group, a sulfonic acid group, a sulfonate group, a sulfonyl group, a carboxyl group, a C₂₋₈ alkoxycarbonyl group, a phenoxycarbonyl group, a carboxylate group, a C₁₋₈ alkyl group, a C₁₋₈ alkoxy group, or a C₆₋₃₀ aryl group; Z is a hydrogen atom, a halogen atom, a cyano group, a C₁₋₈ alkyl group, or C₆₋₁₀ aryl group; and X₁ to X₅ are each independently a hydrogen atom, a halogen atom, a hydroxy group, an alkyl group, an amine group optionally substituted with a C₁₋₁₆ alkyl group, an alkoxy group, an aryl group, or an aryloxy group, and

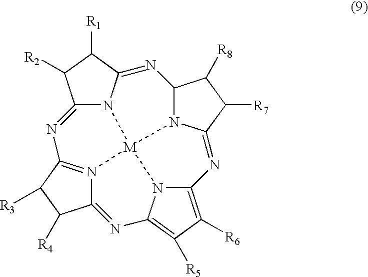

where R₁ to R₈ are each independently a hydrogen atom, a halogen atom, a substituted or unsubstituted alkyl group, a substituted or unsubstituted aryl group, a substituted or unsubstituted alkoxy group, a substituted or unsubstituted aryloxy group, or a substituted or unsubstituted 5-membered ring having at least one nitrogen atom, in which the substituent is a halogen atom, an alkylthio group, a C₁₋₅ alkoxy group, a C₆₋₁₀ aryloxy group, or a C₁₋₁₆ alkylamino group; and M is a divalent, trivalent or tetravalent metal atom coordinated with two hydrogen atoms, an oxygen atom, a halogen atom or a hydroxy group or a non-coordinated metal atom.

The divalent metal atom includes Cu, Zn, Fe, Co, Ni, Ru, Rd, Pd, Mn, Sn, Mg, Ti, etc. The metal atom substituted with an oxygen atom includes VO, MnO, TiO, etc. The monosubstituted trivalent metal atom includes Al—Cl, Ga—Cl, In—Cl, Fe—Cl, Ru—Cl, etc. The disubstituted tetravalent metal atom includes SiCl₂, GaCl₂, TiCl₂, SnCl₂, Si(OH)₂, Ge(OH)₂, Mn(OH)₂, Sn(OH)₂, etc.

A color control dye useful in the present invention may be an antraquinone, phthalocyanine or thioindigo dye.

The film for a PDP filter according to the present embodiment can be formed by integrating a NIR absorption film and a Neon cut film via simultaneous introduction of the NIR absorbing dye, the Neon cut dye and the color control dye. In this case, the process of producing a PDP filter can be simplified.

The film for a PDP filter according to the present embodiment can be formed using any method known in the art. For example, the film for a PDP filter can be formed by dissolving a SAN copolymer in a solvent to prepare a binder solution, adding a NIR absorbing dye, a Neon cut dye, a color control dye, or a mixture thereof to the binder solution, coating the mixture on a filter substrate, and then drying the coating. The coating process may be carried out using various methods, such as spray coating, roll coating, bar coating, or spin coating. The solvent may be a general-purpose organic solvent. Organic solvents, for example, methyl ethyl ketone (MEK), tetrahydrofurane (THF), acetone, ethyl acetate (EA), and toluene can preferably be used. In the formation of a conventional film for a PDP filter, chloroform which is a major cause for environmental pollution and is subjected to regulation must be used as a solvent. In the present invention, a general organic solvent can be used, and thus a solvent recovery system is not required. Thus, the present invention has processing advantages in that a film can be easily formed and production costs can be reduced.

A PDP filter according to another embodiment of the present invention includes the film for a PDP filter, an antireflection film (AR film), and an electromagnetic interference shielding film (EMI film), and may further include a black anodized layer. The PDP filter does not only absorb NIR but also protects panel, prevents reflection, performs color correction, improves color reproduction and contrast, and acts as an electromagnetic shield and a Neon light shield.

A PDP according to another embodiment of the present invention includes the PDP filter described above.

The present invention will now be described in greater detail with reference to the following examples. The following examples are for illustrative purposes only and are not intended to limit the scope of the invention.

### EXAMPLE 1

Formation of NIR Absorption Film

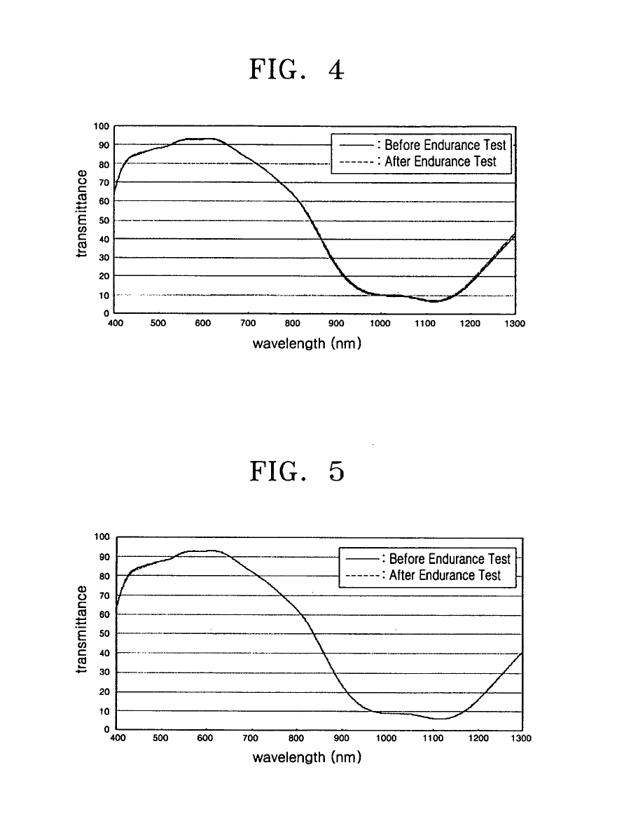

27 g of a SAN copolymer (available from LG Chem) having a weight average molecular weight of 140,000, a Tg of 105° C., and an acrylonitrile content of 27 wt % was dissolved in 73 g of THF to prepare a 27% binder solution. Then, 0.4 g of a diimmonium salt dye (ADS1065A) was added to 100 g of the binder solution and stirred to prepare a mixed solution. The mixed solution was coated on a transparent PET film via bar coating to a dry coating thickness of 15 μm. The coating was dried at 120° C. for 5 minutes to obtain an NIR absorption film. Table 1 shows a change in transmittance before and after the film sat at 80° C. for 500 hrs and at 60° C. under a relative humidity (RH) of 90% for 500 hrs. FIGS. 4 and 5 are transmittance spectrums obtained before and after each endurance test. The durability of the film for a PDP filter was evaluated by measuring a change in the transmittance of the film containing the dye before and after exposing the film to a high-temperature condition or a high-temperature and high-humidity condition. The change in transmittance was lower when the film had better durability.

### EXAMPLE 2

Formation of NIR Absorption Film

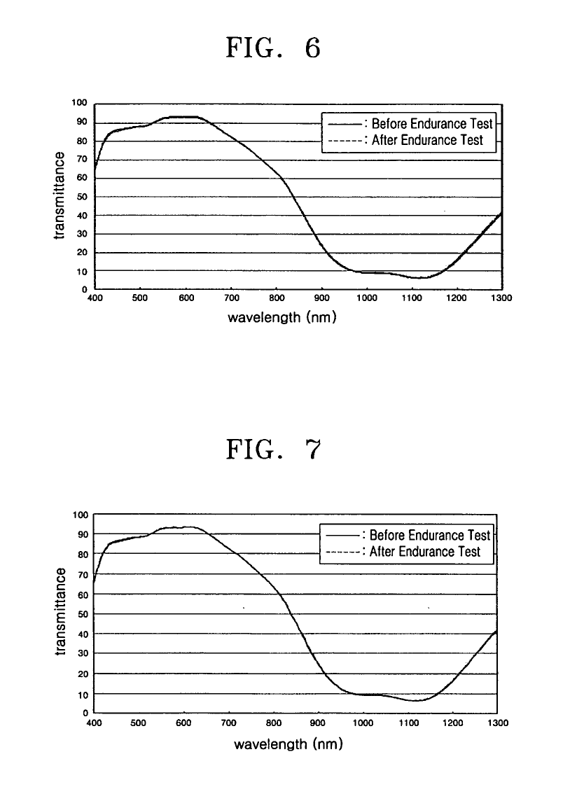

30 g of a SAN copolymer (available from LG Chem) having a weight average molecular weight of 140,000, a Tg of 105° C., and an acrylonitrile content of 27 wt % was dissolved in 70 g of MEK to prepare a 30% binder solution. Then, 0.4 g of a diimmonium salt dye (ADS1065A) was added to 100 g of the binder solution and stirred to prepare a mixed solution. The mixed solution was coated on a transparent PET film via bar coating to a dry coating thickness of 15 μm. The coating was dried at 120° C. for 5 minutes to obtain an NIR absorption film. Table 1 shows a change in transmittance obtained before and after the film sat at 80° C. for 500 hrs and at 60° C. under a RH of 90% for 500 hrs. FIGS. 6 and 7 are transmittance spectrums obtained before and after each endurance test.

TABLE 1

| | | | | | | | NIR range | |
|---|---|---|---|---|---|---|---|---|
| | | Visible light range (nm) | | | | | (nm) | |
| | | 430 | 450 | 550 | 586 | 628 | 850 | 950 |
| Ex- | Initial | 82.0 | 84.7 | 92.3 | 92.9 | 92.8 | 46.1 | 13.0 |
| am- | transmittance | | | | | | | |
| ple 1 | (%) | | | | | | | |
| | Transmittance | 81.5 | 84.2 | 92.0 | 92.6 | 92.5 | 46.8 | 13.7 |
| | (%) after | | | | | | | |
| | 500 hrs | | | | | | | |
| | at 80° C. | | | | | | | |
| | Change in | −0.5 | −0.5 | −0.3 | −0.3 | −0.3 | +0.7 | +0.7 |
| | transmittance | | | | | | | |
| | (%) | | | | | | | |
| Ex- | Initial | 81.6 | 84.4 | 92.3 | 92.8 | 92.6 | 44.3 | 11.9 |
| am- | transmittance | | | | | | | |
| ple 1 | (%) | | | | | | | |
| | Transmittance | 81.0 | 83.7 | 92.2 | 92.7 | 92.6 | 44.3 | 11.8 |
| | (%) after | | | | | | | |
| | 500 hrs | | | | | | | |
| | at 60° C. | | | | | | | |
| | and RH of | | | | | | | |
| | 90% | | | | | | | |
| | Change in | −0.6 | −0.7 | −0.1 | −0.1 | 0.0 | 0.0 | −0.1 |
| | transmittance | | | | | | | |
| | (%) | | | | | | | |
| Ex- | Initial | 83.6 | 86.2 | 92.3 | 93.0 | 92.9 | 44.9 | 11.9 |
| am- | transmittance | | | | | | | |
| ple 2 | (%) | | | | | | | |
| | Transmittance | 83.8 | 85.4 | 91.9 | 92.6 | 92.4 | 45.1 | 12.4 |
| | (%) after | | | | | | | |
| | 500 hrs | | | | | | | |
| | at 80° C. | | | | | | | |
| | Change in | +0.2 | −0.8 | −0.4 | −0.4 | −0.5 | +0.2 | +0.5 |
| | transmittance | | | | | | | |
| | (%) | | | | | | | |
| Ex- | Initial | 83.8 | 86.3 | 92.4 | 93.1 | 93.0 | 45.4 | 12.2 |
| am- | transmittance | | | | | | | |
| ple 2 | (%) | | | | | | | |
| | Transmittance | 83.3 | 85.7 | 92.4 | 93.1 | 93.0 | 45.4 | 12.4 |
| | (%) after | | | | | | | |
| | 500 hrs | | | | | | | |
| | at 60° C. | | | | | | | |
| | and RH of | | | | | | | |
| | 90% | | | | | | | |
| | Change in | −0.5 | −0.6 | 0.0 | 0.0 | 0.0 | 0.0 | +0.2 |
| | transmittance | | | | | | | |
| | (%) | | | | | | | |

### EXAMPLE 3

Formation of NIR Absorption Film

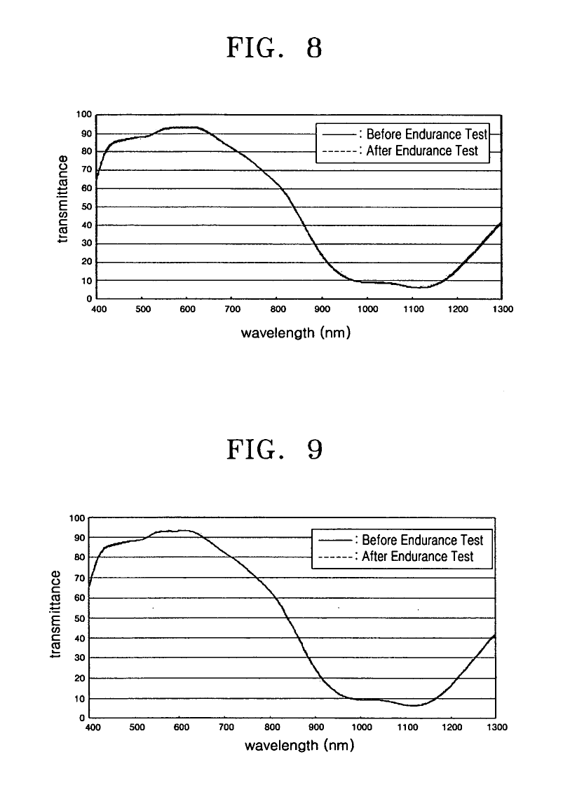

27 g of a SAN copolymer (available from LG Chem) having a weight average molecular weight of 140,000, a Tg of 105° C., and an acrylonitrile content of 27 wt % was dissolved in 73 g of THF to prepare a 27% binder solution. Then, 0.4 g of a diimmonium salt dye (ADS1065A) and 0.25 g of a dithiol-based nickel complex dye (V-63, available from Epoin) were added to 100 g of the binder solution and stirred to prepare a mixed solution. The mixed solution was coated on a transparent PET film via bar coating to a dry coating thickness of 15 μm. The coating was dried at 120° C. for 5 minutes to obtain an NIR absorption film. Table 2 shows a change in transmittance before and after the film sat at 80° C. for 500 hrs and at 60° C. under a RH of 90% for 500 hrs. FIGS. 8 and 9 are transmittance spectrums obtained before and after each endurance test.

### EXAMPLE 4

Formation of NIR Absorption Film

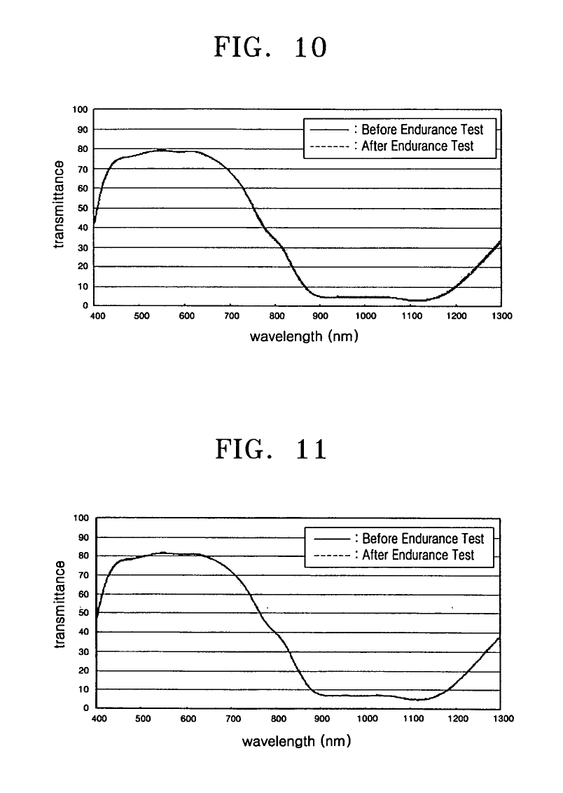

30 g of a SAN copolymer (available from LG Chem) having a weight average molecular weight of 140,000, a Tg of 105° C., and an acrylonitrile content of 27 wt % was dissolved in 70 g of MEK to prepare a 30% binder solution. Then, 0.4 g of a diimmonium salt dye (ADS1065A) and 0.2 g of a phthalocyanine dye (IR12, available from Nippon Shokubai Co., Ltd) were added to 100 g of the binder solution and stirred to prepare a mixed solution. The mixed solution was coated on a transparent PET film via bar coating to a dry coating thickness of 15 μm. The coating was dried at 120° C. for 5 minutes to obtain an NIR absorption film. Table 2 shows a change in transmittance before and after the film sat at 80° C. for 500 hrs and at 60° C. under a RH of 90% for 500 hrs. FIGS. 10 and 11 are transmittance spectrums obtained before and after each endurance test.

TABLE 2

| | | | | | | | NIR range | |
|---|---|---|---|---|---|---|---|---|
| | | Visible light range (nm) | | | | | (nm) | |
| | | 430 | 450 | 550 | 586 | 628 | 850 | 950 |
| Ex- | Initial | 67.6 | 74.0 | 86.0 | 84.8 | 85.2 | 13.1 | 5.6 |
| am- | transmittance | | | | | | | |
| ple 3 | (%) | | | | | | | |
| | Transmittance | 66.4 | 72.9 | 85.6 | 84.5 | 85.0 | 14.2 | 6.4 |
| | (%) after | | | | | | | |
| | 500 hrs | | | | | | | |
| | at 80° C. | | | | | | | |
| | Change in | −1.2 | 1.1 | −0.4 | −0.3 | −0.2 | +1.1 | +0.8 |
| | transmittance | | | | | | | |
| | (%) | | | | | | | |
| Ex- | Initial | 70.1 | 76.1 | 87.2 | 86.2 | 86.5 | 15.9 | 7.3 |
| am- | transmittance | | | | | | | |
| ple 3 | (%) | | | | | | | |
| | Transmittance | 69.1 | 75.1 | 86.8 | 85.8 | 86.2 | 16.0 | 7.5 |
| | (%) after | | | | | | | |
| | 500 hrs | | | | | | | |
| | at 60° C. | | | | | | | |
| | and RH of | | | | | | | |
| | 90% | | | | | | | |
| | Change in | −1.0 | −1.0 | −0.4 | −0.4 | −0.3 | +0.1 | +0.2 |
| | transmittance | | | | | | | |
| | (%) | | | | | | | |
| Ex- | Initial | 67.7 | 73.8 | 79.1 | 78.2 | 78.2 | 15.4 | 4.5 |
| am- | transmittance | | | | | | | |
| ple 4 | (%) | | | | | | | |
| | Transmittance | 66.6 | 72.9 | 78.8 | 77.9 | 77.8 | 16.2 | 4.9 |
| | (%) after | | | | | | | |
| | 500 hrs | | | | | | | |
| | at 80° C. | | | | | | | |
| | Change in | −1.1 | −0.9 | −0.3 | −0.3 | −0.4 | +0.8 | +0.4 |
| | transmittance | | | | | | | |
| | (%) | | | | | | | |
| Ex- | Initial | 71.3 | 76.8 | 81.6 | 80.9 | 80.9 | 20.2 | 7.0 |
| am- | transmittance | | | | | | | |
| ple 4 | (%) | | | | | | | |
| | Transmittance | 70.2 | 75.7 | 81.4 | 80.6 | 80.5 | 20.2 | 7.1 |
| | (%) after | | | | | | | |
| | 500 hrs | | | | | | | |
| | at 60° C. | | | | | | | |
| | and RH of | | | | | | | |
| | 90% | | | | | | | |
| | Change in | −1.1 | −1.1 | −0.2 | −0.3 | −0.4 | 0.0 | +0.1 |
| | transmittance | | | | | | | |
| | (%) | | | | | | | |

### EXAMPLE 5

Formation of NIR Absorption/Neon Cut Composite Film

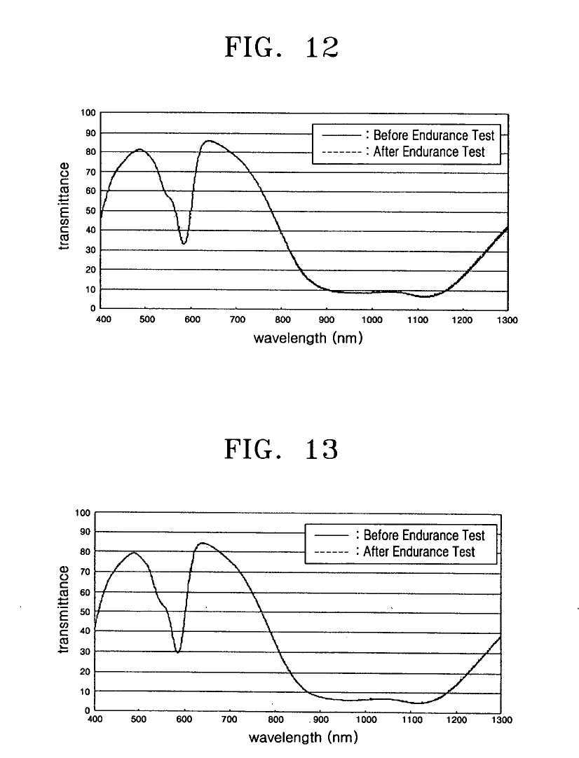

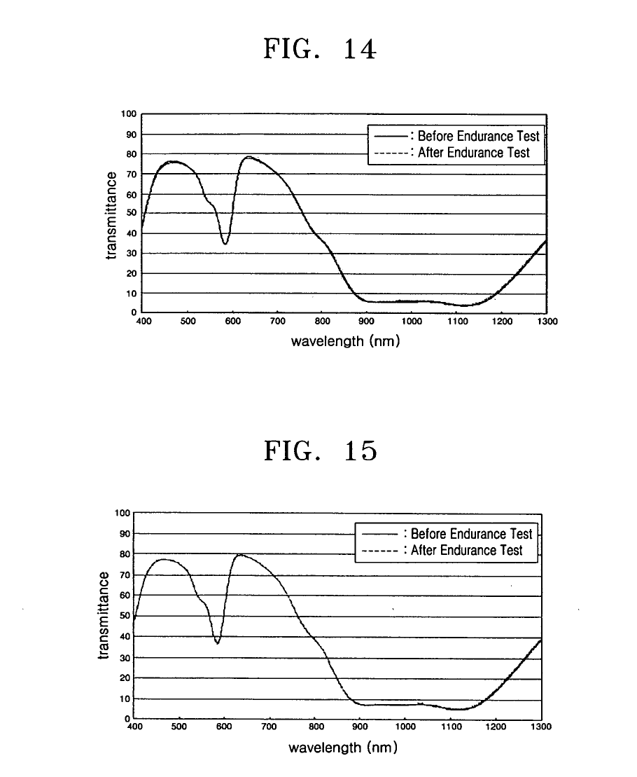

27 g of a SAN copolymer (available from LG Chem) having a weight average molecular weight of 140,000, a Tg of 105° C., and an acrylonitrile content of 27 wt % was dissolved in 73 g of THF to prepare a 27% binder solution. Then, 0.4 g of a diimmonium salt dye (ADS1065A), 0.25 g of a dithiol-based nickel complex dye (V-63, available from Epoin), and 0.03 g of a polymethine dye (TY102, available from Asahi Denka) were added to 100 g of the binder solution and stirred to prepare a mixed solution. The mixed solution was coated on a transparent PET film via bar coating to a dry coating thickness of 15 μm. The coating was dried at 120° C. for 5 minutes to obtain an NIR absorption/Neon cut composite film. Table 3 shows a change in transmittance before and after the film sat at 80° C. for 500 hrs and at 60° C. under a RH of 90% for 500 hrs. FIGS. 12 and 13 are transmittance spectrums obtained before and after each endurance test.

### EXAMPLE 6

Formation of NIR Absorption/Neon Cut Composite Film

30 g of a SAN copolymer (available from LG Chem) having a weight average molecular weight of 140,000, a Tg of 105° C., and an acrylonitrile content of 27 wt % was dissolved in 70 g of MEK to prepare a 30% binder solution. Then, 0.4 g of a diimmonium salt dye (ADS1065A), 0.2 g of a phthalocyanine dye (IR12, available from Nippon Shokubai Co., Ltd), and 0.03 g of a polymethine dye (TY102, available from Asahi Denka) were added to 100 g of the binder solution and stirred to prepare a mixed solution. The mixed solution was coated on a transparent PET film via bar coating to a dry coating thickness of 15 μm. The coating was dried at 120° C. for 5 minutes to obtain an NIR absorption/Neon cut composite film. Table 3 shows a change in transmittance before and after the film sat at 80° C. for 500 hrs and at 60° C. under a RH of 90% for 500 hrs. FIGS. 14 and 15 are transmittance spectrums obtained before and after each endurance test.

TABLE 3

| | | | | | | | NIR range | |
|---|---|---|---|---|---|---|---|---|
| | | Visible light range (nm) | | | | | (nm) | |
| | | 430 | 450 | 550 | 586 | 628 | 850 | 950 |
| Ex- | Initial | 68.2 | 74.7 | 57.1 | 33.2 | 84.8 | 17.3 | 8.2 |
| am- | transmittance | | | | | | | |
| ple 5 | (%) | | | | | | | |
| | Transmittance | 67.5 | 73.9 | 57.0 | 33.1 | 84.7 | 17.9 | 8.6 |
| | (%) after | | | | | | | |
| | 500 hrs | | | | | | | |
| | at 80° C. | | | | | | | |
| | Change in | −0.7 | −0.8 | −0.1 | −0.1 | −0.1 | +0.6 | +0.4 |
| | transmittance | | | | | | | |
| | (%) | | | | | | | |
| Ex- | Initial | 65.5 | 72.3 | 53.7 | 29.4 | 83.2 | 14.5 | 6.2 |
| am- | transmittance | | | | | | | |
| ple 5 | (%) | | | | | | | |
| | Transmittance | 65.1 | 71.6 | 53.9 | 29.7 | 83.3 | 14.4 | 6.5 |
| | (%) after | | | | | | | |
| | 500 hrs | | | | | | | |
| | at 60° C. | | | | | | | |
| | and RH of | | | | | | | |
| | 90% | | | | | | | |
| | Change in | −0.4 | −0.7 | +0.2 | +0.3 | +0.1 | −0.1 | +0.3 |
| | transmittance | | | | | | | |
| | (%) | | | | | | | |
| Ex- | Initial | 69.2 | 75.2 | 55.6 | 34.4 | 77.9 | 17.6 | 5.8 |
| am- | transmittance | | | | | | | |
| ple 6 | (%) | | | | | | | |
| | Transmittance | 67.8 | 73.8 | 55.0 | 34.2 | 77.2 | 18.0 | 6.2 |
| | (%) after | | | | | | | |
| | 500 hrs | | | | | | | |
| | at 80° C. | | | | | | | |
| | Change in | −1.4 | −1.4 | −0.6 | −0.2 | −0.7 | +0.4 | +0.4 |
| | transmittance | | | | | | | |
| | (%) | | | | | | | |
| Ex- | Initial | 70.4 | 76.2 | 57.4 | 36.6 | 78.9 | 19.7 | 7.0 |
| am- | transmittance | | | | | | | |
| ple 6 | (%) | | | | | | | |
| | Transmittance | 69.7 | 75.3 | 57.1 | 36.6 | 78.7 | 19.5 | 7.3 |
| | (%) after | | | | | | | |
| | 500 hrs | | | | | | | |
| | at 60° C. | | | | | | | |
| | and RH of | | | | | | | |
| | 90% | | | | | | | |
| | Change in | −0.7 | −0.9 | −0.3 | 0.0 | −0.2 | −0.2 | +0.3 |
| | transmittance | | | | | | | |
| | (%) | | | | | | | |

### EXAMPLE 7

Formation of NIR Absorption/Neon Cut Composite Film

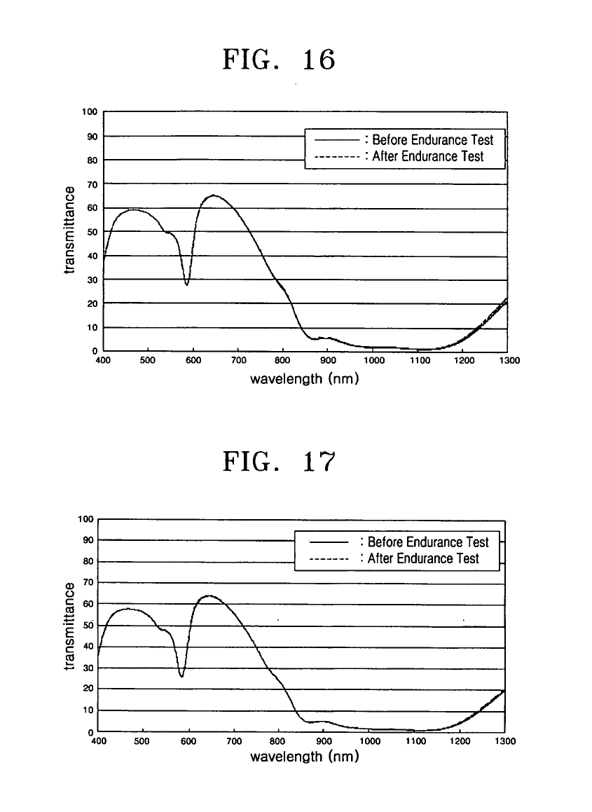

30 g of a SAN copolymer (available from LG Chem) having a weight average molecular weight of 140,000, a Tg of 105° C., and an acrylonitrile content of 27 wt % was dissolved in 70 g of MEK to prepare a 30% binder solution. Then, 0.63 g of a diimmonium salt dye (ADS1065A) and 0.052 g of a cyanine dye (NKX2766, available from Hiyashibara) as NIR absorbing dyes, 0.038 g of a porphyrine dye (PD319, available from Mitsui Chemical) as a Neon cut dye, and 0.065 g of V-TR (available from CIBA), 0.025 g of B-An (available from Nippon Kayaku), and 0.005 g of B-RR (available from Bayer) were added to 100 g of the binder solution and stirred to prepare a mixed solution. The mixed solution was coated on a transparent PET film via bar coating to a dry coating thickness of 15 μm. The coating was dried at 120° C. for 5 minutes to obtain an NIR absorption/Neon cut composite film. Table 4 shows a change in transmittance before and after the film sat at 80° C. for 500 hrs and at 60° C. under a RH of 90% for 500 hrs. FIGS. 16 and 17 are transmittance spectrums obtained before and after each endurance test.

TABLE 4

| | | | | | | | NIR range | |
|---|---|---|---|---|---|---|---|---|
| | | Visible light range (nm) | | | | | (nm) | |
| | | 430 | 450 | 550 | 585 | 628 | 850 | 950 |
| Ex- | Initial | 60.9 | 64.1 | 53.9 | 30.2 | 70.2 | 8.4 | 3.2 |
| am- | transmittance | | | | | | | |
| ple 7 | (%) | | | | | | | |
| | Transmittance | 60.6 | 63.7 | 54.0 | 30.3 | 70.2 | 8.8 | 3.4 |
| | (%) after | | | | | | | |
| | 500 hrs | | | | | | | |
| | at 80° C. | | | | | | | |
| | Change in | −0.3 | −0.4 | 0.1 | 0.1 | 0.0 | 0.4 | 0.2 |
| | transmittance | | | | | | | |
| | (%) | | | | | | | |
| Ex- | Initial | 59.3 | 62.5 | 52.1 | 28.4 | 68.8 | 7.5 | 2.7 |
| am- | transmittance | | | | | | | |
| ple 7 | (%) | | | | | | | |
| | Transmittance | 59.2 | 62.1 | 52.5 | 28.7 | 69.1 | 7.5 | 2.7 |
| | (%) after | | | | | | | |
| | 500 hrs | | | | | | | |
| | at 60° C. | | | | | | | |
| | and RH of | | | | | | | |
| | 90% | | | | | | | |
| | Change in | −0.1 | −0.4 | 0.4 | 0.3 | 0.3 | 0.0 | 0.0 |
| | transmittance | | | | | | | |
| | (%) | | | | | | | |

### COMPARATIVE EXAMPLE 1

Formation of NIR Absorption Film

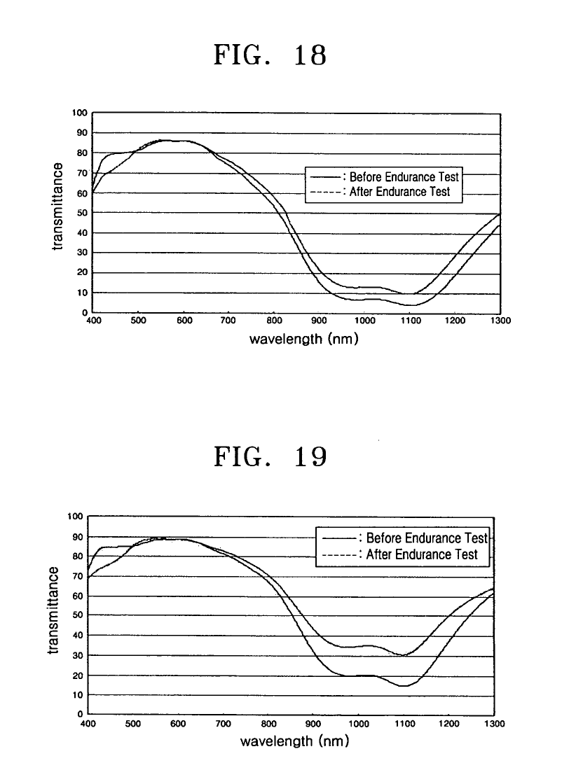

30(?) g of a polyester resin (vylron, available from Toyobo) was dissolved in 70 g of 1,3-Dioxonal to prepare a 30% binder solution. Then, 0.4 g of a diimmonium salt dye (ADS1065A) was added to 100 g of the binder solution and stirred to prepare a mixed solution. The mixed solution was coated on a transparent PET film via bar coating to a dry coating thickness of 15 μm. The coating was dried at 120° C. for 5 minutes to obtain an NIR absorption film. Table 5 shows a change in transmittance before and after the film sat at 80° C. for 500 hrs and at 60° C. under a RH of 90% for 500 hrs. FIGS. 18 and 19 are transmittance spectrums obtained before and after each endurance test.

### COMPARATIVE EXAMPLE 2

Formation of NIR Absorption Film

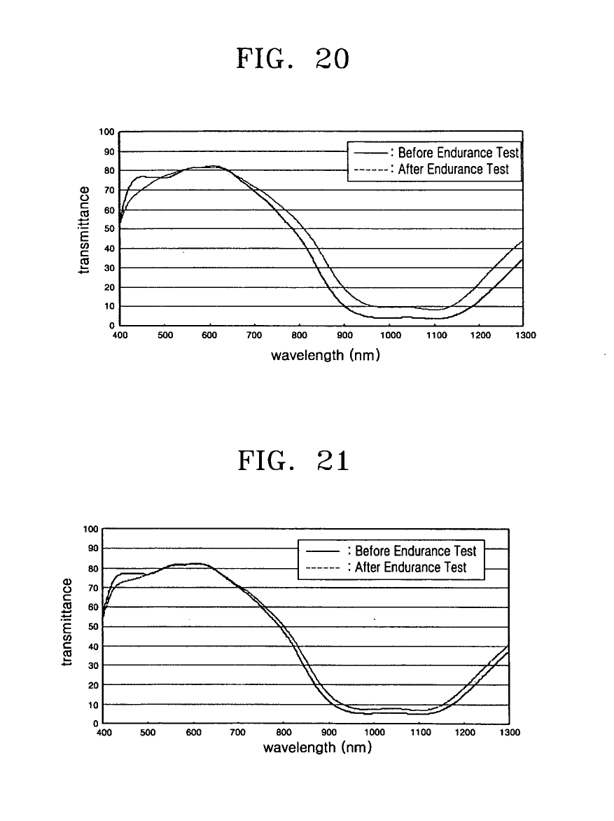

10 g of a polycarbonate resin (grade:201-15, available from LG Chem) was dissolved in 90 g of 1,3-Dioxonal to prepare a 10% binder solution. Then, 0.4 g of a diimmonium salt dye (ADS1065A) was added to 100 g of the binder solution and stirred to prepare a mixed solution. The mixed solution was coated on a transparent PET film via bar coating to a dry coating thickness of 15 μm. The coating was dried at 120° C. for 5 minutes to obtain an NIR absorption film. Table 5 shows the change in transmittance before and after the film sat at 80° C. for 500 hrs and at 60° C. under a RH of 90% for 500 hrs. FIGS. 20 and 21 are transmittance spectrums obtained before and after each endurance test.

TABLE 5

| | | | | | | | NIR range | |
|---|---|---|---|---|---|---|---|---|
| | | Visible light range (nm) | | | | | (nm) | |
| | | 430 | 450 | 550 | 586 | 628 | 850 | 950 |
| Comparative | Initial | 77.8 | 79.4 | 85.7 | 85.6 | 84.8 | 34.8 | 7.9 |
| Example 1 | transmittance | | | | | | | |
| | (%) | | | | | | | |
| | Transmittance | 69.3 | 72.2 | 86.2 | 85.8 | 84.6 | 39.7 | 14.0 |
| | (%) after 500 hrs at | | | | | | | |
| | 80° C. | | | | | | | |
| | Change in | −8.5 | −7.2 | +0.5 | +0.2 | −0.2 | +4.9 | +6.1 |
| | transmittance | | | | | | | |
| | (%) | | | | | | | |
| Comparative | Initial | 83.9 | 84.8 | 88.1 | 88.3 | 88.1 | 52.2 | 21.3 |
| Example 1 | transmittance | | | | | | | |
| | (%) | | | | | | | |
| | Transmittance | 74.0 | 76.0 | 89.0 | 88.5 | 87.8 | 58.5 | 35.3 |
| | (%) after 500 hrs at | | | | | | | |
| | 60° C. and RH of 90% | | | | | | | |
| | Change in | −9.9 | −8.8 | +0.9 | +0.2 | −0.3 | +6.3 | +14.0 |
| | transmittance | | | | | | | |
| | (%) | | | | | | | |
| Comparative | Initial | 74.7 | 76.7 | 78.3 | 81.5 | 81.4 | 25.9 | 4.9 |
| Example 2 | transmittance | | | | | | | |
| | (%) | | | | | | | |
| | Transmittance | 66.7 | 70.3 | 80.8 | 81.4 | 81.0 | 36.7 | 11.2 |
| | (%) after 500 hrs | | | | | | | |
| | at 80° C. | | | | | | | |
| | Change in | −0.8 | −6.4 | +2.5 | −0.1 | −0.4 | +10.8 | +6.3 |
| | transmittance | | | | | | | |
| | (%) | | | | | | | |
| Comparative | Initial | 75.2 | 77.1 | 81.0 | 81.8 | 81.7 | 27.6 | 5.9 |
| Example 2 | transmittance | | | | | | | |
| | (%) | | | | | | | |
| | Transmittance | 70.6 | 73.1 | 80.8 | 81.6 | 81.5 | 32.1 | 8.4 |
| | (%) after 500 hrs at | | | | | | | |
| | 60° C. and RH of 90% | | | | | | | |
| | Change in | −4.6 | −4.0 | −0.2 | −0.2 | −0.2 | +4.5 | +2.5 |
| | transmittance | | | | | | | |
| | (%) | | | | | | | |

### COMPARATIVE EXAMPLE 3

Formation of NIR Absorption Film

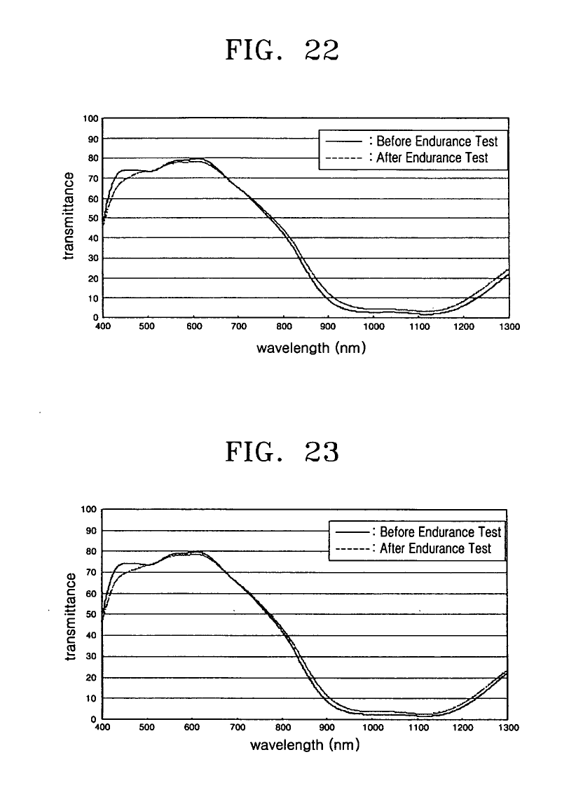

10 of a polysulfon resin (available from BASF) was dissolved in 90 g of 1,3-Dioxonal to prepare a 10% binder solution. Then, 0.4 g of a diimmonium salt dye (ADS1065A) was added to 100 g of the binder solution and stirred to prepare a mixed solution. The mixed solution was coated on a transparent PET film via bar coating to a dry coating thickness of 15 μm. The coating was dried at 120° C. for 5 minutes to obtain an NIR absorption film. Table 6 shows a change in transmittance before and after the film sat at 80° C. for 500 hrs and at 60° C. under a RH of 90% for 500 hrs. FIGS. 22 and 23 are transmittance spectrums obtained before and after each endurance test.

### COMPARATIVE EXAMPLE 4

Formation of NIR Absorption Film

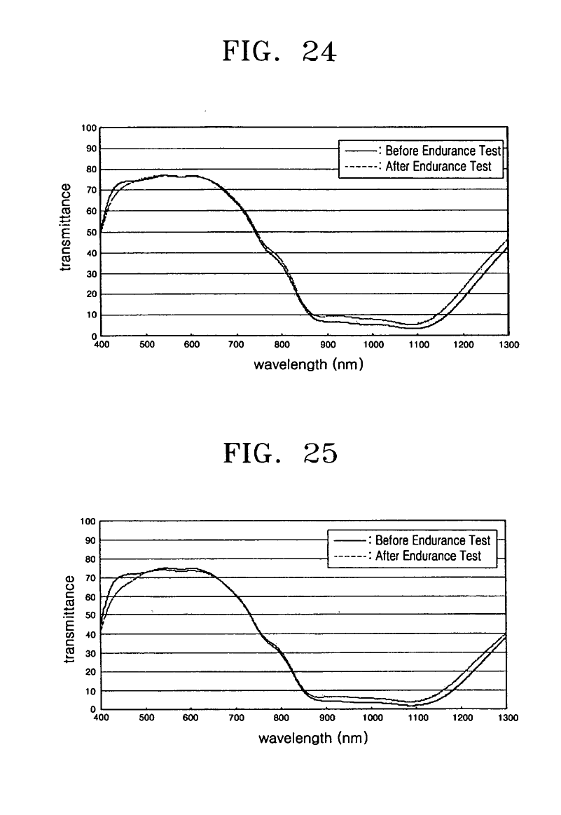

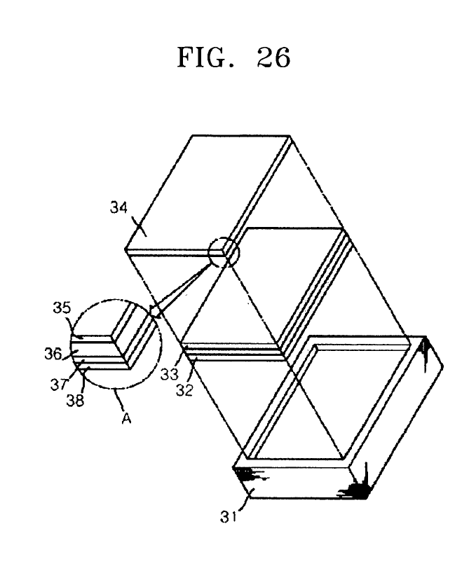

26 g of a polymethylmethacrylate (PMMA) resin with a weight average molecular weight of 50,000 was dissolved in 74 g of MEK to prepare a 26% binder solution. Then, 0.4 g of a diimmonium salt dye (ADS1065A) and 0.2 g of a phthalocyanine dye were added to 100 g of the binder solution and stirred to prepare a mixed solution. The mixed solution was coated on a transparent PET film via bar coating to a dry coating thickness of 20 μm. The coating was dried at 150° C. for 5 minutes to obtain an NIR absorption film. Table 6 shows a change in transmittance before and after the film sat at 80° C. for 500 hrs and at 60° C. under a RH of 90% for 500 hrs. FIGS. 24 and 25 are transmittance spectrums obtained before and after each endurance test.

TABLE 6

| | | | | | | | NIR range | |
|---|---|---|---|---|---|---|---|---|
| | | Visible light range (nm) | | | | | (nm) | |
| | | 430 | 450 | 550 | 586 | 628 | 850 | 950 |
| Comparative | Initial | 71.3 | 74.1 | 77.9 | 78.9 | 78.8 | 24.4 | 3.5 |
| Example 3 | transmittance | | | | | | | |
| | (%) | | | | | | | |
| | Transmittance | 65.1 | 69.4 | 77.2 | 77.9 | 77.5 | 27.6 | 5.8 |
| | (%) after 500 hrs | | | | | | | |
| | at 80° C. | | | | | | | |
| | Change in | −6.2 | −4.7 | 0.7 | −1.0 | −1.3 | +3.2 | +2.3 |
| | transmittance | | | | | | | |
| | (%) | | | | | | | |
| Comparative | Initial | 71.3 | 74.1 | 78.0 | 78.9 | 78.8 | 23.9 | 3.4 |
| Example 3 | transmittance | | | | | | | |
| | (%) | | | | | | | |
| | Transmittance | 65.5 | 69.3 | 77.2 | 78.1 | 77.8 | 27.0 | 5.2 |
| | (%) after 500 hrs at | | | | | | | |
| | 60° C. and RH of 90% | | | | | | | |
| | Change in | −5.8 | −4.8 | −0.8 | −0.8 | −1.0 | +3.1 | +1.8 |
| | transmittance | | | | | | | |
| | (%) | | | | | | | |
| Comparative | Initial | 70.9 | 73.9 | 76.8 | 76.3 | 75.7 | 12.8 | 5.8 |
| Example 4 | transmittance | | | | | | | |
| | (%) | | | | | | | |
| | Transmittance | 67.0 | 71.5 | 76.8 | 76.3 | 75.7 | 13.9 | 8.8 |
| | (%) after 500 hrs | | | | | | | |
| | at 80° C. | | | | | | | |
| | Change in | −2.9 | −2.4 | 0.0 | 0.0 | 0.0 | +1.1 | +3.0 |
| | transmittance | | | | | | | |
| | (%) | | | | | | | |
| Comparative | Initial | 67.6 | 71.0 | 74.8 | 74.1 | 73.5 | 9.3 | 3.7 |
| Example 4 | transmittance | | | | | | | |
| | (%) | | | | | | | |
| | Transmittance | 60.1 | 65.0 | 73.8 | 73.2 | 72.7 | 10.3 | 6.5 |
| | (%) after 500 hrs at | | | | | | | |
| | 60° C. and RH of 90% | | | | | | | |
| | Change in | −7.5 | −6.0 | −1.0 | −0.9 | −0.8 | +1.0 | +2.8 |
| | transmittance | | | | | | | |
| | (%) | | | | | | | |

From Tables 1 to 6, it can be seen that the films obtained in Comparative Examples 1-4 has the change in transmittance ranging from −9.9 to 14, indicating poor durability, whereas the films obtained in Examples 1-7 show little change in transmittance, indicating that they have superior durability even under a high temperature condition or a high-temperature and high-humidity condition for a long time.

FIG. 26 is an exploded perspective view of a PDP according to an embodiment of the present invention. As enlarged in the circle A, a PDP filter 34 may include a substrate 36, an AR film 35 formed on a front surface of the substrate 36, an EMI film 37 formed on a rear surface of the substrate 36 and a NIR absorption film or NIR absorption/Neon cut film 38 for a PDP filter formed on the EMI film 37. In the PDP filter 34, the substrate 36 may be a glass or plastic substrate. The EMI film 37 is formed by depositing on the substrate 36 a thin metal plate which has been etched in a certain pattern and black anodized to increase contrast or by depositing a conductive fiber on the substrate 36.

The PDP of the present embodiment has a general PDP structure except that the PDP filter 34 including the NIR absorption film or the NIR absorption/Neon cut composite film prepared in the above Examples is used. Referring to FIG. 26, the PDP includes a panel assembly 33 displaying an image, a printed circuit substrate 32 disposed on a rear surface of the panel assembly 33, having electronic components for driving the PDP mounted thereon, the PDP filter 34 disposed on a front surface of the panel assembly 33, a case 31 accommodating the panel assembly 33, the printed circuit substrate 32 and the PDP filter 34, and a cover (not shown) on the PDP filter (34).

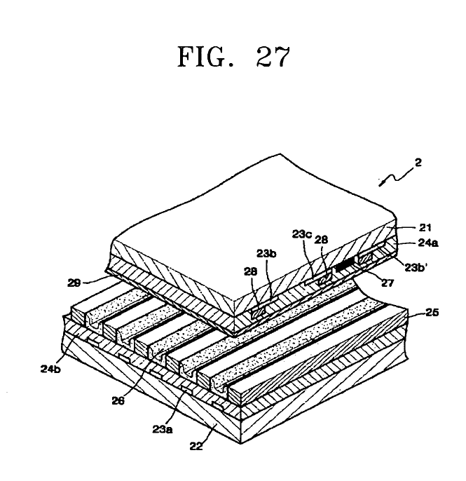

FIG. 27 is a schematic diagram of the panel assembly 33 for a PDP according to an embodiment of the present invention. Referring to FIG. 27, the panel assembly 33 includes a front substrate 21 and a rear substrate 22 facing each other. Address electrodes 23a are formed on the rear substrate 22; a dielectric layer 24b covers the address electrodes 23a; barrier ribs 25 maintaining a discharge distance and preventing electrooptical cross-talk between pixels are formed on the dielectric layer 24b; and a phosphor layer 26 is formed on at least one side of a discharge space defined by the barrier ribs 25. On the front substrate 21, common electrodes 23b and scan electrodes 23c are formed in a direction crossing the address electrodes 23a. A dielectric layer 24a covering the common electrodes 23b and the scan electrodes 23c is formed on a lower surface of the front substrate 21 and a MgO layer 29 is formed thereon. A certain gas is injected into a discharge space defined by the rear substrate 22 and the front substrate 21.

In the PDP, when a voltage is applied to the address electrodes 23a and the scan electrodes 23c, pre-discharge occurs there to form charged particles on a lower surface of the dielectric layer 24a. In this state, sustain discharge occurs. The sustain discharge occurs on the surface of the dielectric layer 24a by applying a voltage to the common electrodes 23b and the scan electrode 23c. At this time, phosphors are excited by ultraviolet rays generated by plasma formed in a gas layer to form pixels. Thus, a pair of the common and scan electrode 23b and 23c forms one discharge cell, i.e., one pixel. Meanwhile, the common and scan electrodes 23b and 23c on the front substrate 21 are composed of transparent electrodes. To reduce the line resistance, bus electrodes 28 with a width smaller than the transparent electrodes are formed on the common and scan electrodes 23b and 23c.

The film for a PDP filter according to an embodiment of the present invention includes a SAN copolymer as a binder resin, and thus a change in transmittance is low under a high-temperature condition or a high-temperature and high humidity condition, resulting in good durability and thermal stability and high transmittance in a visible light range. Further, since a general organic solvent can be used in the formation of the film, environmental pollution is reduced and the removal of a poisonous solvent is not required, thereby simplifying a process of forming the film.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A film for a plasma display panel (PDP) filter comprising:
a binder resin composed of a styrene-acrylonitrile (SAN) copolymer; and
a dye selected from the group consisting of a near infrared ray (NIR) absorbing dye, a Neon cut dye, a color control dye, and a mixture thereof.

2. The film of claim 1, wherein the content of an acrylonitrile unit in the binder resin may be 10-50 wt %.

3. The film of claim 1, wherein the binder resin may have a weight average molecular weight of 10,000-1,000,000 and a glass transition temperature of 100-120° C.

4. The film of claim 1, wherein the NIR absorbing dye is selected from the group consisting of diimmonium salt, quinone, metal complex, phthalocyanine, naphthalocyanine, cyanine dyes, and a mixture thereof.

5. The film of claim 4, wherein when the NIR absorbing dye is a diimmonium salt dye, a weight ratio of the binder resin and the NIR absorbing dye is 5:1 to 200:1.

6. The film of claim 4, wherein the diimmonium salt dye is a compound containing a diimmonium cation represented by formula (1): 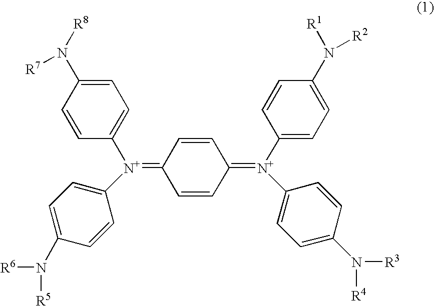
where R¹ to R⁸ are each independently a hydrogen atom, a substituted or unsubstituted C₁₋₁₆ alkyl group, or a substituted or unsubstituted C₆₋₃₀ aryl group.

7. The film of claim 4, wherein the metal complex dye is a compound represented by formula (2) or (3): 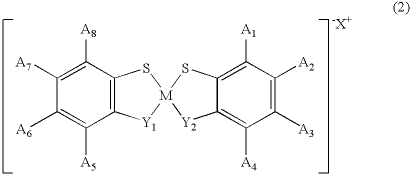
where A₁ to A₈ are each independently a hydrogen atom, a halogen atom, a nitro group, a cyano group, a thiocyanato group, a cyanato group, an acyl group, a carbamoyl group, an alkylaminocarbonyl group, an alkoxycarbonyl group, an aryloxycarbonyl group, a substituted or unsubstituted alkyl group, a substituted or unsubstituted aryl group, a substituted or unsubstituted alkoxy group, a substituted or unsubstituted aryloxy group, a substituted or unsubstituted alkylthio group, a substituted or unsubstituted arylthio group, a substituted or unsubstituted alkylamino group, a substituted or unsubstituted arylamino group, a substituted or unsubstituted alkylcarbonylamino group, or a substituted or unsubstituted arylcarbonylamino group, in which the substituent is a halogen atom, a C₁₋₅ alkoxy group, a C₆₋₁₀ aryloxy group, or a C₁₋₁₆ alkylamino group;
Y₁ and Y₂ are each independently oxygen or sulfur;
X⁺ is a quaternary ammonium or a quaternary phosphonium; and
M¹ is Ni, Pt, Pd or Cu, and 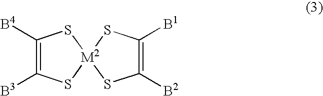
where B¹ to B⁴ are each independently a hydrogen atom, a cyano group, a hydroxy group, a nitro group, an alkoxy group, an aryloxy group, an alkylthio group, a fluoroalkyl group, an acyl group, a carbamoyl group, an alkylaminocarbonyl group, an alkoxycarbonyl group, an aryloxycarbonyl group, a substituted or unsubstituted aryl group, or a substituted or unsubstituted naphthyl group, in which the substituent is a halogen atom, an alkylthio group, a C₁₋₅ alkoxy group, a C₆₋₁₀ aryloxy group, or a C₁₋₁₆ alkylamino group; and
M² is Ni, Pt, Pd or Cu.

8. The film of claim 4, wherein the phthalocyanine dye is a compound represented by formula (4) and the naphthalocyanine dye is a compound represented by formula (5): 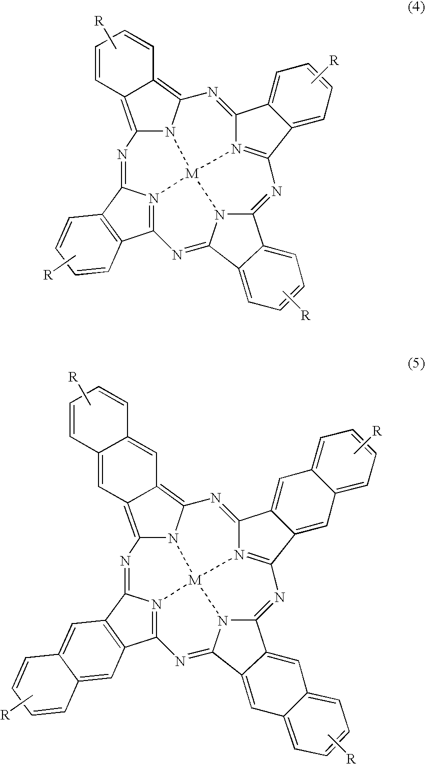
where R is a hydrogen atom, a halogen atom, a substituted or unsubstituted alkyl group, a substituted or unsubstituted aryl group, a substituted or unsubstituted alkoxy group, a substituted or unsubstituted aryloxy group, or a substituted or unsubstituted 5-membered ring having at least one nitrogen atom, in which the substituent is a halogen atom, an alkylthio group, a C₁₋₅ alkoxy group, a C₆₋₁₀ aryloxy group, or a C₁₋₁₆ alkylamino group.

9. The film of claim 4, wherein the cyanine dye may be a compound represented by formula (10):
Ar₁-A-Ar₂ (10)
where A is a substituted or unsubstituted C₅₋₇ hydrocarbylene group forming a conjugated double bond; and
Ar₁ and Ar₂ are each independently a substituted or unsubstituted aryl group, a substituted or unsubstituted heterocyclic group, or a polycyclic group having a substituted or unsubstituted heterocycle.

10. The film of claim 4, wherein the cyanine dye is at least one compound selected from the group consisting of compounds represented by formulae (11) to (18):

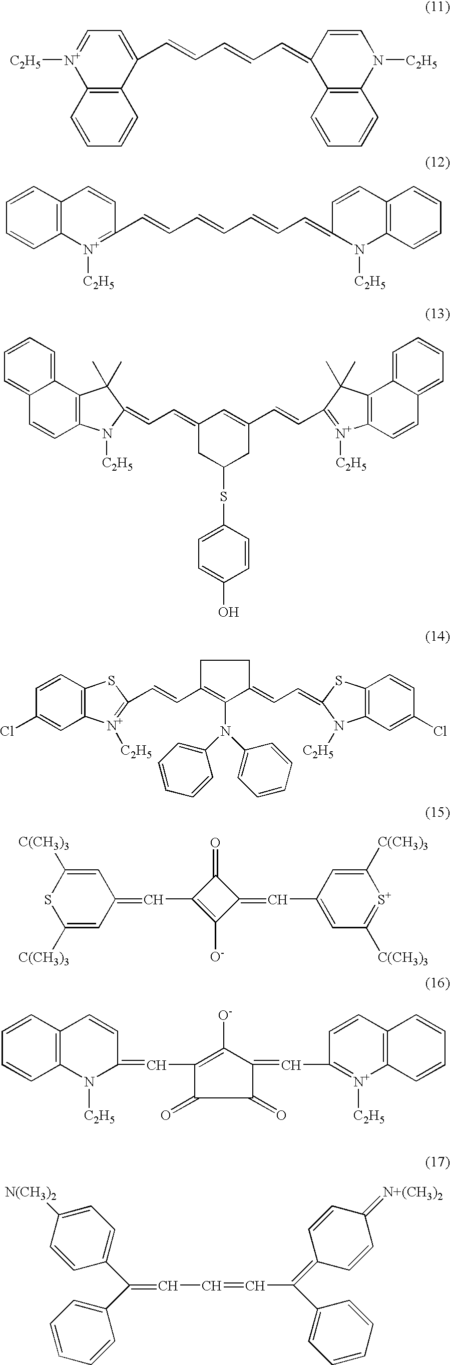

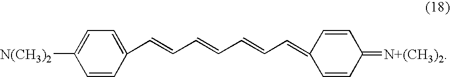

11. The film of claim 1, wherein the Neon cut dye has a maximum absorption wavelength of 570-600 nm and is a polymethine dye represented by formula (6), (7) or (8) or a porphyrine dye represented by formula (9): 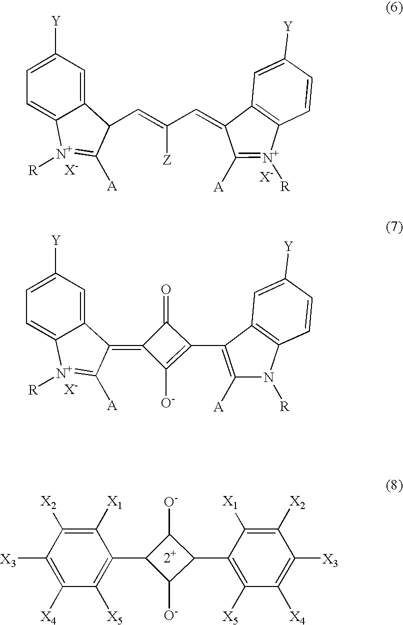
where R is a hydrogen atom or a C₁₋₁₆ aliphatic hydrocarbon;
A is a hydrogen atom, a C₁₋₈ alkyl group, or C₆₋₃₀ aryl group;
Y is a halogen atom, a nitro group, a cyanine group, a sulfonic acid group, a sulfonate group, a sulfonyl group, a carboxyl group, a C₂₋₈ alkoxycarbonyl group, a phenoxycarbonyl group, a carboxylate group, a C₁₋₈ alkyl group, a C₁₋₈ alkoxy group, or a C₆₋₃₀ aryl group;
Z is a hydrogen atom, a halogen atom, a cyano group, a C₁₋₈ alkyl group, or C₆₋₁₀ aryl group; and
X₁ to X₅ are each independently a hydrogen atom, a halogen atom, a hydroxy group, an alkyl group, an amine group optionally substituted with a C₁₋₁₆ alkyl group, an alkoxy group, an aryl group, or an aryloxy group, and 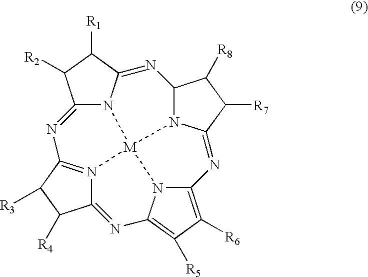
where R₁ to R₈ are each independently a hydrogen atom, a halogen atom, a substituted or unsubstituted alkyl group, a substituted or unsubstituted aryl group, a substituted or unsubstituted alkoxy group, a substituted or unsubstituted aryloxy group, or a substituted or unsubstituted 5-membered ring having at least one nitrogen atom, in which the substituent is a halogen atom, an alkylthio group, a C₁₋₅ alkoxy group, a C₆₋₁₀ aryloxy group, or a C₁₋₁₆ alkylamino group; and
M is a divalent to tetravalent metal atom coordinated with two hydrogen atoms, an oxygen atom, a halogen atom or a hydroxy group or a non-coordinated metal atom.

12. The film of claim 1, wherein the color control dye is an antraquinone dye, phthalocyanine dye, or a thioindigo dye.

13. The film of claim 1, which comprises an integrated NIR absorption film and Neon cut film.

14. A PDP filter comprising:
the film of claim 1;
an antireflection layer; and
an electromagnetic interference shielding film.

15. A plasma display panel produced by using the PDP filter of claim 14.
